(19) United States
(12) Patent Application Publication
(10) Pub. No.: US 2022/0028234 A1
(43) Pub. Date: Jan. 27, 2022

(54) Active security system and a method to detect and neutralize armed intruders

(71) Applicant: Mirza Faizan, Irving, TX (US)

(72) Inventors: Mirza Faizan, Irving, TX (US); Mirza Rizwan, Patna (IN); Rania Khan, Frisco, TX (US); Reem Khan, Frisco, TX (US); Affan Mehmood, Frisco, TX (US); Rayyan Mehmood, Frisco, TX (US); Iman Waheed, Frisco, TX (US); Essam Waheed, Frisco, TX (US); Noah Sheikh, Plano, TX (US); Maleeha Khan, Frisco, TX (US)

(21) Appl. No.: 17/185,058

(22) Filed: Feb. 25, 2021

Related U.S. Application Data
(60) Provisional application No. 62/982,684, filed on Feb. 27, 2020.

(51) Int. Cl. G08B 13/196; G08B 15/00; G06N 20/00

(52) U.S. Cl. CPC G08B 13/1963; G08B 13/19645; G06N 20/00; G08B 13/19689; G08B 15/00; G08B 13/19656

(57) ABSTRACT

Active video surveillance and security system to detect armed intruders and neutralize them without human intervention, including video surveillance cameras, infra-red cameras, and thermal cameras with artificially intelligent image processing software and mounted on pan and tilt mechanism to lock on the armed intruders, laser pointer, firing barrels with different ammunitions, speaker and remote monitoring through control, display and alert unit (CDAU) running on a digital computer. The video cameras are arranged on a casing that is surrounded by another concentric casing which has a plurality of firing barrels. The AI-IP cameras detect an armed intruder and raise an alarm on the CDAU to enable a user to visually verify an intruder and select appropriate ammunition to fire and neutralize the intruder remotely.

### TECHNICAL FIELD

The present invention relates to safety and security systems, more specifically to a system and a method for detecting and neutralizing armed intruders or perpetrators with sufficient warning, and informs a user at a remote-central location so that the user may use appropriate ammunition to neutralize the intruder.

### BACKGROUND OF THE INVENTION

In recent decades, fear of armed intruders has arisen in the United States of America and is slowly spreading across the globe. There have been instances of random shooting at public places like schools, universities, places of worship, and other such places. These incidents claim thousands of innocent and defenseless lives, many of which are women and children. According to a Washington Post analysis report in December 2019, 1,165 lives have been lost in mass shootings in the US alone since 1966. When an armed intruder enters a building with an intention to harm occupants, he is always successful in inflicting harm, injury, and causing death as it takes some time before police or first responders arrive at the scene to neutralize the armed intruder.

Previous attempts to counter such drawbacks related to passive security systems were in the form of the ‘Intrusion Security System’ of different functional mechanisms (U.S. Pat. No. 7,965,171; US 2008/0191857), which simply detect a breach of the perimeter of the private property or real-estate and generate an alarm. Other attempts were in the form of sophisticated cameras and video analysis (EP 0578508; EP 1337962; U.S. Pat. Nos. 5,631,697; 5,877,809; 7,810,273), which can be used to detect or identify armed intrusion but unable to neutralize intruders. Nevertheless, mass shootings persist, as the system raising alarm against armed intruders on a spree of mass shooting will not make much difference though.

All of these conventional methods/systems or a computer program product, and some other method/system presently known in the art have had some flaws in design or mechanism and lacks precision. Most of the existing devices are too expensive and time consuming to be practical for most users. Some shortfalls of the existing method/system or a computer program product include manual interference. In light of this, there is a need for a method/system or a computer program product that overcomes these constraints.

In light of these facts, it is of great advantage to the security system and its occupants that there is a system that is better equipped and better qualified to make real-time decisions and take real-time and effective action against an armed intruder. There is a need for a security system that provides an integrated system that uses to detect and also use to neutralize armed intruders.

None of the above inventions and patents, taken either alone or in combination, is seen to describe the present invention as claimed herein. Thus, a security system for detecting and neutralizing armed intruders or perpetrators and solving the aforementioned problems is desired.

### SUMMARY OF THE INVENTION

An exemplary embodiment of a system of the present invention uses artificial intelligent image processing (AI-IP) cameras that are installed at one or more strategic locations of a building, wherein the strategic location is a location from where the cameras can film a site at the building from more than one angle. The cameras are of two types, wherein the first type of camera is equipped with required artificial intelligent image processing systems and a second type of camera is equipped with firing barrels on recoiled spring (as shown in FIG. 1). The first type and the second type of cameras are mounted on a pan and tilt mechanism. The number of the first type and the second type of cameras to be installed in the building is decided based on the structure of the building.

According to an exemplary embodiment of the present invention, the first type of the camera automatically detects any intruder/s with arms/ammunition/weapons. Upon detection of the intruder with arms, and an alarm with a live video is sent to a central security monitoring control room along with an alert sent to a local police station or a law enforcement/security agency. As soon as the intruder/s with arms is identified as being potentially dangerous, the user in a central security monitoring and control room may decide on selecting ammunition from a set of ammunition to be used to neutralize the intruder, wherein the ammunition is one of rubber bullets, pellets, laser guns, a hollow bullet, and live bullets or any other means of neutralizing the intruder/s with arms.

As soon as the ammunition is selected by the user, the artificial intelligent image processing (AI-IP) cameras communicate with the other similar cameras in the building network to locate the movement of the intruder and fire to neutralize the intruder after one or more warning announcements. For example, if the camera detects that the intruder is exiting from room number 1 and going towards room number 2, then the cameras and ammunitions focus towards an entry point of room number 2 to fire at the intruder, based on the selection of the ammunition from a set of ammunitions by the user, as soon as the intruder is visible. This neutralizes the armed intruder without human intervention and human loss of life (as shown in FIG. 2).

In an embodiment of the present invention, there is disclosed, a network-enabled real-time based security system, said system comprising a plurality of the first type of artificially intelligent image processing video surveillance cameras; a plurality of the second type of cameras communicatively coupled to said plurality of the first type of cameras; wherein each of said second type of the camera is configured to trigger ammunition based on a detection; and an alarming unit. The alarming unit alarms plurality of entities based on the identification of an intruder and/or triggering action performed by said plurality of the second type of cameras.

Numerous additional features, embodiments, and benefits of the methods and apparatus of the present invention are discussed below in the detailed description which follows.

### BRIEF DESCRIPTION OF THE DRAWINGS

The accompanying drawings illustrate various embodiments of systems, methodₛ, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 shows an essential component of the second type of the AI-IP camera, according to the present invention;

FIG. 2 demonstrates the security zones conceptualized by the security system, according to the present invention;

FIG. 3 is a schematic depiction of a central security monitoring and control room, according to the present invention; and

FIG. 4 is a flowchart showing various options and stages associated with the present invention.

### DETAILED DESCRIPTION OF DRAWINGS

The present disclosure is best understood with reference to the detailed figures and description set forth herein. Various embodiments are discussed below with reference to the figures. However, those skilled in the art will readily appreciate that the detailed descriptions given herein concerning the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment,” “an embodiment,” “at least one embodiment,” “one example,” “an example,” “for example,” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

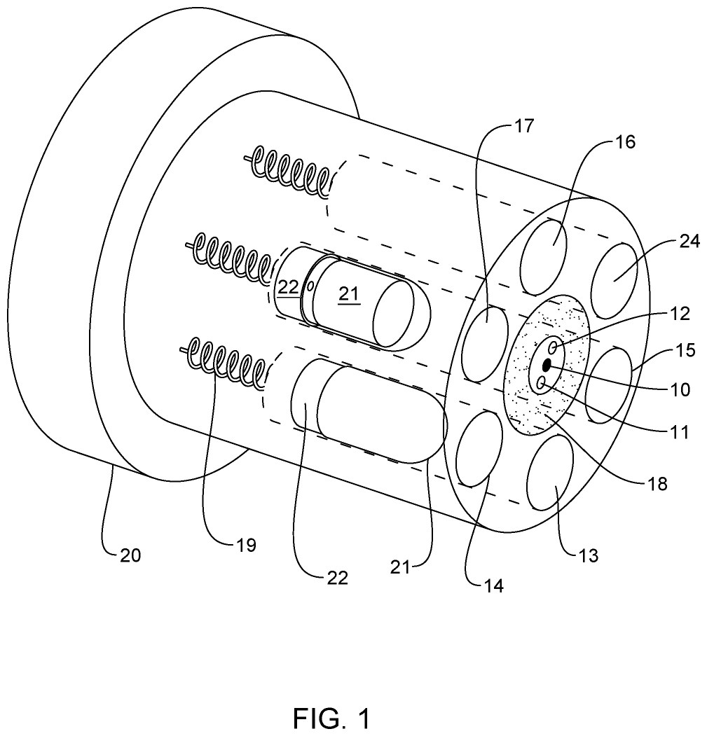

FIG. 1 shows an essential component of the second type of the AI-IP camera according to the present invention. The second type of AP-IP camera includes several cameras of a different type as per the need like a thermal camera 12 and a video surveillance camera 11, wherein the surveillance camera 11 works in both day and night modes and arranged around a laser pointer. At the center of the cameras, there is a laser pointer hole 10 to point at an intruder after the detection of the armed intruder. The second type of AP-IP camera includes a speaker 18, which is embedded in a pan and tilt housing, which announces a warning to the intruder and raises an alarm in a building. Further, the AP-IP camera includes a cylindrical casing, wherein the cylindrical casing includes number of barrels with different ammunitions such as a taser shooter barrel 13, a rubber-bullet shooter barrel 14, a pellet shooter barrel 15, a hollow bullet 24, .22 a bore bullet shooter barrel 16; and 9 mm bullet shooter barrel 17, wherein each of the barrels are concentric to the cylindrical casing.

Once the user at a central security monitoring and control room analyzes and confirms the intruder with an arm on a screen and selects ammunition from a set of ammunition to be used to neutralize the intruder, the selected barrel fires the selected type-of bullet after giving a warning to the intruder. Each ammunition barrel assembly has a bullet chamber, inside the bullet chamber there is a bullet, behind the bullet there is a firing pin, and recoil spring. The firing pin is a means to fire the bullets and in one embodiment it is a linear solenoid-based shooting pin. When the system fires against a target, the recoil force pushes the spring backward as the spring recoils. The actual position of the cameras other equipment varies depending on the type of building, vehicle, airplane, or other premises. For example, cameras on a public bus could be inside the vertical steadying handles or at the underside of an overhead luggage hold. In a bank, the cameras could be camouflaged in the ceiling construction together with the smoke alarms and water sprinklers. The main factor is that, together, the cameras cover all possible areas where people may be present.

The cylindrical casing is covered with a bullet-proof covering 23 from top to bottom to safeguard the AP-IP camera from a back shot by the armed intruder in response to the warning announcements. The AP-IP camera is mounted on the pan and tilts mechanism and can follow the intruder and keep a watch constantly on the intruder.

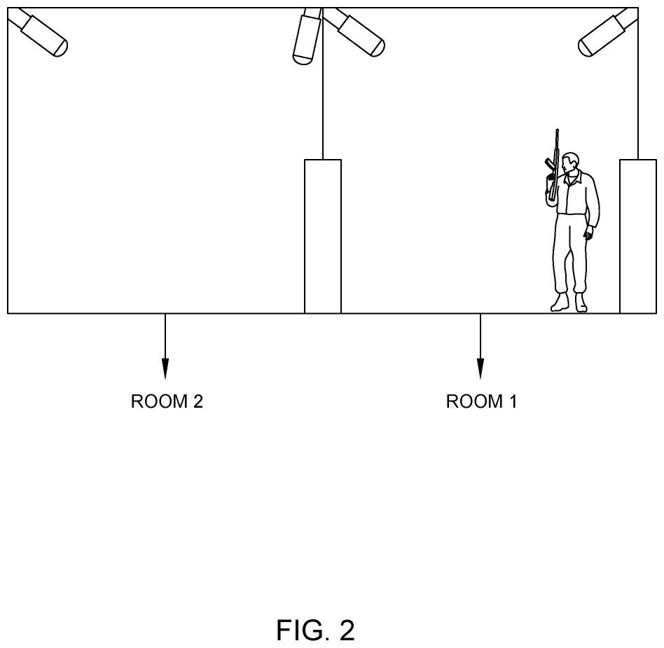

FIG. 2 demonstrates number of security zones conceptualized as according to the present invention, wherein room 1 and room 2 has the first type and the second type of the camera in different combination as per the room area, wherein the first type of the camera is used for initial identification of the intruder with arm, and the second type of the camera is used for subsequent identification and firing at the armed intruder.

According to an exemplary embodiment of the present invention, as shown in FIG. 2, each of the cameras in the network communicates location information of the intruder and work in unison. For example, if the intruder goes from room 1 towards room 2, each of the cameras in room 2 will aim at the door of room 2 to shoot as soon as the intruder is visible. As such, the mounted cameras may be embedded with motion sensors, thermal sensors, and voice detection sensors or alike. The sensor may be adapted to sense acoustic/sonic/barometric pressure (and changes therein) (e.g., acoustic pressure detected from an ultrasonic piezo sensor or Piezo crystal-coated metal), at least one InfraRed (IR) sensor to sense muzzle flash and/or body heat (e.g., changes relative to background, differentiation of IR signals, etc.), and a Nitrogen sensor to sense nitrogen found in the nitro celluloid used in single-stage accelerants and nitroglycerin found in dual-stage accelerants).

In an exemplary embodiment, the camera may include an acoustic sensor that may comprise MEMS microphones, which have an omnidirectional pickup responsive equally to sounds coming from any direction. In other aspects, the acoustic sensor(s) comprise multiple microphones disposed of in an array to form a directional response or a beam pattern. In yet other aspects, the acoustic sensor(s) comprise a beamforming microphone array that can be designed to be more sensitive to sound coming from one or more specific directions than sound coming from other directions and can employ beamforming techniques such as, but not limited to, conventional (fixed or switched beam) beamforming, adaptive beamforming phased array, desired signal maximization mode, and interference signal minimization or cancellation mode.

The sound waves sensed by the acoustic sensor(s) are, of course, also influenced by the structures in the room, occupants in the room, and the like, and require significant computing power to properly interpret. In at least some aspects, one or more acoustic sensors utilize an ultrasonic transducer as a receiver to detect the waves of a gunshot, which helps to reduce the influence of ambient noise and other unwanted waveforms. The high energy created from the gunshot has a signature, unlike most common waveforms. Accordingly, an ultrasonic transducer can detect threat waveforms while ignoring all others.

In an exemplary embodiment, in at least some aspects, the system may be integrated with other electronic devices at the place of installation, such other electronic devices including televisions, radios, and other potentially distracting electronic devices, so that the disclosed system can automatically turn off any such other electronic devices after a threat (e.g., a shooter) has been detected. Optionally, the disclosed system may selectively turn on one or more such other electronic devices as a threat countermeasure.

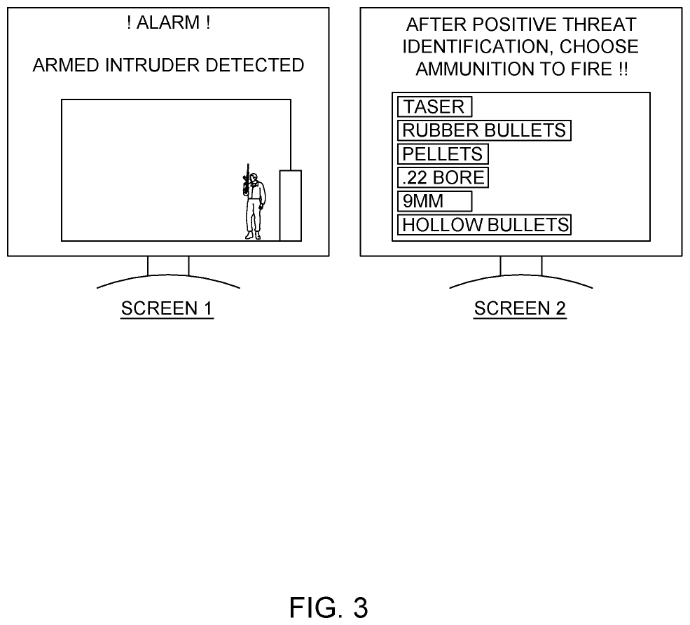

FIG. 3 shows a central security monitoring and control display screen, wherein the user sees the armed intruder in real-time on screen 1, and then selects ammunition from a set of ammunitions, wherein the set of ammunitions is depicted on a screen 2, by the user used to neutralize the intruder, wherein the ammunition may be one of the rubber bullets, pellets, laser guns, a hollow bullet, and live bullets or any other means of neutralizing the intruder/s with arms and armed threat. Screen 1 only shows live video of the intruder, wherein the user may zoom and verify for arms and the second screen brings up an options screen for selecting ammunition from a set of ammunitions, as per an arrangement done before installation of the security system, to select appropriate ammunition to neutralize the armed intruder.

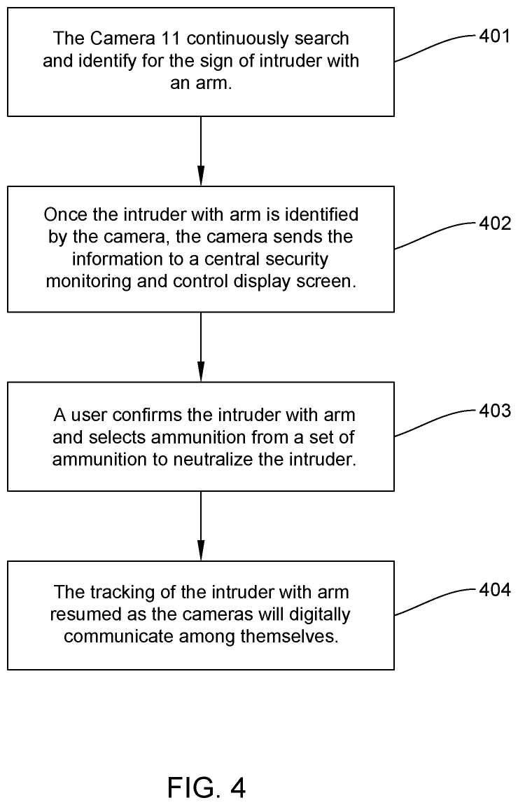

FIG. 4 is a flowchart showing various options and stages associated with the present invention. The system includes software programs, screens, cameras, speakers, and control panel.

At step 401, Camera 11 continuously searches and identifies for the sign of the armed intruder.

At step 402, once the armed intruder is identified by the camera, the camera sends the information to a central security monitoring and control display screen.

At step 403, a user confirms the armed intruder and selects ammunition from a set of ammunition to neutralize the intruder.

At step 404, the tracking of the armed intruder is resumed as the cameras digitally communicate among themselves.

An exemplary embodiment of a system of the present invention uses the artificial intelligent image processing (AI-IP) cameras that are installed at one or more strategic location of a building and identifying an armed intruder through a series of AP-IP cameras as shown in FIG. 1, The AI-IP cameras are of two types, the first type of cameras is a surveillance camera without any firing barrels and the second type of cameras are armed with appropriate ammunition to neutralize an armed threat, in addition to surveillance cameras. Upon detecting an armed intruder in the perimeter or inside the building, the system identifies a potential threat and raises an alarm to a remote user with live video for visual verification and confirmation of armed intrusion. The user monitors a security feed to confirm the armed intruder in the building using a control, display, and alert unit embedded software. Once the user confirms the threat, a notification is sent to the local police or law enforcement agency/security agency instantly and an auto-lock is placed on the intruder.

At this point, on screen 2, a message prompts with a list of ammunition, from which the user may select ammunition of choice from the list, to fire at and neutralize the intruder. This ammunition may be customized and may vary based on the user's preference. It may include; BB pellets, taser, bullets, hollow bullet, and many such ammunitions. The user then quickly decides on appropriate ammunition. Once the ammunition has been selected, all other cameras in the building will be alerted and armed based on the selection by the user.

The second type of cameras contain barrels with a variety of ammunition and laser pointer, it will fire based on the user selection unless the remote user changes the ammunition selection or stop firing altogether. At this point, the cameras will follow the target through a pan and tilt mechanism until the target has been neutralized. As the present invention system launches ammunition at the target, it will experience a recoil force thrusting the invention (barrel/the present invention system) backward. To account for this powerful force, each firing barrel is supported by a spring.

According to an embodiment of the invention, the second type of the camera which has firing barrels with live ammunitions will be pointing away from occupants and are activated to aim at intruders only after identification of armed intruders.

According to an embodiment of the present invention, the security system is a combination of the first type and second type of artificially intelligent image processing cameras in a mesh network for video surveillance of defined intruders in terms of its movements and actions to be demonstrated at the remote computer for a swift reaction towards safety and security of the places and public at large or defined groups of people.

In an embodiment of the present invention, the AI-IP cameras can be fed with the defined group of people through a face recognition mechanism, beyond which it will raise alarm or alert through the announcement of the new faces to stand still.

In a further embodiment of the present invention, the nature of ammunition can be decided on the nature of threat perception as per the utility locations like public buildings, restricted areas like defense areas, prohibited areas like industrial zones. Furthermore, the law enforcement authority may be in a better position to license the user for the use of different kinds of ammunition as per the threat perception.

In an exemplary embodiment, the defined target could be an armed intruder or any such target which enters into restricted zones like defense areas or industrial units or in the agricultural field. Additionally, the security staff at the restricted zones can feed real-time visitor profiles to AI-IP cameras, after which the camera will read the visitor to be a safety element in the restricted zone instead of an intruder, thus expanding the scope of the utility of the present invention.

In an embodiment of the present invention, to safeguard the AI-IP cameras, the external casing of AI-IP cameras may be such that it must not get damaged under severe calamities like that of aircraft Blackbox. This may further help to study the efficiency and alertness of security staff deployed. The shooting mechanism could be anything as per the need and not to be restricted to a linear solenoid-based shooting pin only. Furthermore, CDAU can also be developed as a mobile app for remote monitoring by the user.

It is noted that various connections are set forth between elements in the description and in the drawings (the contents of which are included in this disclosure by way of reference). It is noted that these connections in general and, unless specified otherwise, may be direct or indirect and that this specification is not intended to be limiting in this respect. In this respect, a coupling between entities may refer to either a direct or an indirect connection.

Various embodiments of the invention have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the Internet. The computer further comprises a microprocessor. The microprocessor is connected to a communication bus. The computer also includes a memory. The memory may be Random Access Memory (RAM) or Read-Only Memory (ROM). The computer system further comprises a storage device, which may be a hard-disk drive or a removable storage drive, such as, a floppy disk drive, optical disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as the reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

To process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, “C,” “C++,” “Visual C++,” Java, and “Visual Basic.” Further, the software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, “Unix,” “DOS,” “Android,” “Symbian,” and “Linux.”

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various implementations of the systems and techniques described here can be realized in digital electronic circuitry, integrated circuitry, specially designed ASICs (application-specific integrated circuits), computer hardware, firmware, software, and/or combinations thereof. These various implementations can include implementation in one or more computer programs that are executable and/or interpretable on a programmable system including at least one programmable processor, which may be special or general-purpose, coupled to receive data and instructions from and to transmit data and instructions to, a storage system, at least one input device, and at least one output device.

These computer programs (also known as programs, software, software applications, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus, and/or device (e.g., magnetic discs, optical disks, memory, Programmable Logic Devices (PLDs)) used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

A person having ordinary skills in the art will appreciate that the system, modules, and sub-modules have been illustrated and explained to serve as examples and should not be considered limiting in any manner. It will be further appreciated that the variants of the above-disclosed system elements, or modules and other features and functions, or alternatives thereof, may be combined to create other different systems or applications.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The claims can encompass embodiments for hardware, software, or a combination thereof.

Although a few implementations have been described in detail above, other modifications are possible. Moreover, other mechanisms for performing the systems and methods described in this document may be used. Also, the logic flows depicted in the figures may not require the particular order shown, or sequential order, to achieve desirable results. Other steps may be provided, or steps may be eliminated, from the described flows, and other components may be added to, or removed from, the described systems. Accordingly, other implementations are within the scope of the following claims.

### DRAWINGS—REFERENCE NUMERALS

10—Laser pointer
11—Camera hole
12—Thermal camera
13—Taser shooter barrel
14—Rubber-bullet shooter barrel
15—Pellet shooter barrel
16—.22 bore bullet shooter barrel
17—9 mm bullet shooter barrel
18—Speaker
19—Recoil spring
20—Pan and tilt mechanism
21—Bullet chamber
22—linear solenoid-based shooting pin
23—Bullet-proof casing
24—Hollow Bullet

What is claimed is:

1. A network-enabled real-time based security system, said system comprising:
a plurality of first type of artificially intelligent image processing video surveillance cameras;
a plurality of second type of cameras communicatively coupled to said plurality of first type of cameras; wherein each of said second type of camera is configured to trigger ammunition based on a detection; and
an alarming unit; wherein said alarming unit alarms plurality of entities based on identification of an intruder and/or triggering action performed by said plurality of second type of cameras.

2. A security system to detect and neutralize armed intruder/s, comprising;
a. a plurality of first type of artificially intelligent image processing video surveillance camera system along with thermal and infra-red cameras;
b. a plurality of second type of cameras with additional firing barrels loaded with different ammunition and means of firing the ammunition;
c. a laser pointer;
d. a speaker module;
e. means of providing pan and tilt movement;
f. a control, display and alert unit running on a remote computer;
wherein said camera system forms a mesh network among itself and is connected to a remote computer to detect an armed intruder and raise alarm at the control, display, and alert unit that allows a remote user to visually verify and select proper ammunition to neutralize the armed intruder promptly remotely.

3. The system of claim 1, wherein the control, display and alert unit may be downloaded on a mobile device as an application.

4. An artificially intelligent image processing video surveillance and threat neutralizing camera system, comprising;
a. a plurality of video surveillance camera;
b. a thermal camera;
c. an infra-red camera;
d. a laser pointer;
e. a plurality of firing barrels with different types of ammunition; and
wherein said cameras with laser pointer are positioned in the center of inner casing that has a concentric outer casing with the plurality of firing barrels and means of detecting an armed intruder in live video feed and raising alarm on control, display and alert unit whereby a remote user may verify armed intruder and select appropriate ammunition to fire.

5. The artificially intelligent image processing video surveillance and threat neutralizing camera system of claim 4, wherein the firing barrels have means of firing different kinds of bullet and hitting the perpetrators.

6. The artificially intelligent image processing video surveillance and threat neutralizing camera system of claim 4, wherein the firing barrel are supported by recoil spring.
